(19) United States
(12) Patent Application Publication
(10) Pub. No.: US 2025/0375776 A1
(43) Pub. Date: Dec. 11, 2025

(54) ENVIRONMENTALLY-FRIENDLY SURFACTANTS FOR MINERAL BENEFICIATION

(71) Applicant: Colonial Chemical, Inc., South Pittsburg, TN (US)

(72) Inventors: Lucas R. Moore, South Pittsburg, TN (US); Robert N. Comber, South Pittsburg, TN (US)

(21) Appl. No.: 19/102,819

(22) PCT Filed: Aug. 8, 2023
(86) PCT No.: PCT/US23/29791

§ 371 Date: Feb. 10, 2025

Related U.S. Application Data
(60) Provisional application No. 63/396,099, filed on Aug. 8, 2022.

(51) Int. Cl. B03D 1/06; B03D 1/008; C22B 3/12; C22B 11/00; C22B 15/00

(52) U.S. Cl. CPC B03D 1/06; B03D 1/008; C22B 3/12; C22B 11/04; C22B 15/008; B03D 2203/02

(57) ABSTRACT

A composition for use as a collector, leaching aid, sequestrant or chelant, comprising at least one at least one derivatized carbohydrate surfactant such as an alkyl derivatized polyglycoside, glycolipid, glycerol glycolipid, sphingo glycolipid, sulfolipid, phospholipid, glucoside, rhamnolipid, or sophrolipid.

### BACKGROUND OF THE INVENTION

Minerals and metals touch nearly every part of our lives. From the pigments in paint and toothpaste, to the metals in the electronics, and even the minerals used in building materials. However, the days of high-grade mining have long passed. Specialized beneficiation is now required to take a low-grade mineral ore to upgrade or isolate a desired component. The most common ways of doing this are through washing, sizing, flotation, leaching, and selective flocculation. As the demand for these high-grade minerals and metals continues to grow, while grade continues to decline, the sophistication of the chemistry required to assist in the beneficiation process is continuously changing.

Historically, flotation was achieved by some pH modification and the application of surfactant-based collectors, such as xanthates, phosphonates, and saponified fatty acids, depending on the mineralogy and the goal. Leaching was accomplished by an acid or base solutions being sprayed, dripped, or mixed with a metal or mineral containing substrate or mound.

It is herein proposed that a new class of natural surfactants derived from carbohydrates like sugars, that will be further functionalized by chemical modification that can be used for the selective beneficiation of metals or minerals from an undesired gangue mineral, either through direct or reverse flotation.

### SUMMARY OF VARIOUS EMBODIMENTS OF THE INVENTION

One embodiment of the present invention is a composition for a collector, leaching aid, sequestrant or chelant, comprising derivatized carbohydrates to produce things like alkyl derivatized polyglycosides, glycolipids, glycerol glycolipids, sphingo glycolipids, sulfolipids, phospholipids, glucosides, rhamnolipids, sophrolipids, and others.

In another embodiment, the composition comprises a surfactant of the present invention, the surfactant being a crosspolymer of an alkyl polyglucoside.

Another embodiment of the present invention is the use of derivatized alkyl polyglucosides as a collector, sequestrant, leaching aid, or chelant.

Another embodiment of the present invention is a collector, leaching aid, sequestrant or chelant composition for the following minerals including, but not limited to, apatite, fluorapatite, silica, calcium carbonate, calcium sulfate, feldspar, barite, magnesite, bauxite, hematite, and kaolinite; the composition comprising a surfactant of the present invention.

Another embodiment of the present invention is a collector, leaching aid, sequestrant or chelant for the following metals including, but not limited to, the all mineral variations of copper, gold, and nickel.

Another embodiment of the present invention is a formulation composition that comprises a surfactant of the present invention.

In another embodiment of the present invention, the surfactant on the formulation composition is a derivatized alkyl polyglucoside. In aspects of the invention it may be chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment of the present invention, the surfactant is a sorbitan oleate decylglucoside crosspolymer. It should be understood that other crosspolymers can include other alkyl polyglucosides (for example, lauryl polyglucoside), and other sorbitan esters (for example, sorbitan laurate, sorbitan stearate, sorbitan myristate, and sorbitan palmitate).

In another embodiment of the present invention, the derivatized polyglucoside surfactant of the present invention comprises a monosaccharide unit, a disaccharide unit, a linker, and a functionalizing agent.

In another embodiment of the present invention, the derivatized polyglucoside surfactant of the present invention comprises a monosaccharide unit, a disaccharide unit, a linker, a crosslinking agent, and a functionalizing agent.

In another embodiment of the present invention, the composition further comprises a co-surfactant.

### DETAILED DESCRIPTION OF THE INVENTION

The details of one or more embodiments of the presently disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by those of ordinary skill in the art, certain definitions are set forth to facilitate explanation of the presently disclosed subject matter.

Unless defined otherwise, all technical and scientific terms used herein have the same meaning as is commonly understood by one of skill in the art to which the invention(s) belong.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which need to be independently confirmed.

The compositions of the present invention are many times mixtures of alkyl polyglucosides, and optionally a linker arm, and optionally a functionalizing agent, and optionally a crosslinking agent, which are often characterized as constitutional isomers. Constitutional isomers are compounds that have the same general empirical formula but differ in their constitution, i.e. in their structure, such that they can have a different sequence of the atoms and/or different bonds. Constitutional isomers are therefore fundamentally different from stereoisomers, which include both enantiomers and diastereomers.

Constitutional isomers are in many cases grouped into functional isomers, skeletal isomers, positional isomers and bonding isomers. In the case of functional isomers and bonding isomers, the compounds can have different reactivity; for example, ethanol comprises a hydroxyl group, whereas the constitutionally isomeric dimethyl ether has an ether group. Skeletal isomers and positional isomers differ in the branching and/or the position of functional groups, such that these constitutional isomers can have essentially the same functionality. The expression “essentially the same functionality” accordingly means that the underlying functional group, i.e., for example, a hydroxyl group, a phenyl ring or an ester group, is present in all constitutional isomers, but does not take account of altered reactivity of these groups as a result of different substitution. For example, there is a measurable difference in the reactivity of 1-n-butanol and tert-butanol owing to the stereochemistry, but the functionality as such is identical. In this connection, however, these measurable differences that are covered by the term “essentially the same functionality” are to be neglected, since both compounds in the present case have a hydroxyl functionality. On the other hand, propyne has one alkyne functionality and propadiene has two alkene functionalities. Alkenes, by comparison with alkynes, have a different functionality in the context of this invention, since they exhibit different acidity, for example. Therefore, propyne, by comparison with propadiene, does not have “essentially the same functionality”.

The mixtures of the present derivatized alkyl polyglucosides have essentially the same functionality. Accordingly, components of the mixture, while constitutional isomers, are not functional isomers, and instead are skeletal isomers and/or positional isomers. That is, the functional group may be in a different position on the same carbon chain or on the same sugar molecule and have essentially the same functionality.

The term “alkyl” refers to a straight or branched chain monovalent hydrocarbon radical having a specified number of carbon atoms. Alkyl groups may be unsubstituted or substituted with substituents that do not interfere with the specified function of the composition and may be substituted once or twice with the same or different group. Substituents may include alkyl, aryl, alkoxy, hydroxy, mercapto, amino, alkyl substituted amino, nitro, carboxy, carbanyl, carbanyloxy, cyano, methylsulfonylamino, or halogen, for example. Examples of “alkyl” include, but are not limited to, methyl, ethyl, n-propyl, isopropyl, n-butyl, s-butyl, t-butyl, n-pentyl, n-hexyl, 3-methylpentyl, and the like.

The term “surfactant”, “surface active agent”, “surfactant”, or “dispersing agent” refers to an organic chemical that when added to a liquid changes the properties of that liquid at a surface.

“Collector” means a composition of matter that selectively adheres to a particular constituent of the fine and facilitates the adhesion of the particular constituent to the micro-bubbles that result from the sparging of a fine bearing slurry.

“Fine” means a composition of matter containing a mixture of a more wanted material, the beneficiary and a less wanted material, the gangue.

“Frother” or “Frothing Agent” means a composition of matter that enhances the formation of the micro-bubbles and/or preserves the formed micro-bubbles bearing the hydrophobic fraction that result from the sparging of slurry.

“Microemulsion” means a dispersion comprising a continuous phase material, substantially uniformly dispersed within which are droplets of a dispersed phase material, the droplets are sized in the range of approximately from 1 to 100 nm, usually 10 to 50 nm.

The term “slurry” means a mixture comprising a liquid medium within which fines (which can be liquid and/or finely divided solids) are dispersed or suspended. When slurry is sparged, the tailings remain in the slurry and at least some of the concentrate adheres to the sparge bubbles and rises up out of the slurry into a froth layer above the slurry, the liquid medium may be entirely water, partially water, or may not contain any water at all.”

Stable Emulsion” means an emulsion in which droplets of a material dispersed in a carrier fluid that would otherwise merge to form two or more phase layers are repelled from each other by an energy barrier, the energy barrier may be higher than, as low as 20 kT, or lower, the repulsion may have a half-life of a few years. Enabling descriptions of emulsions and stable emulsions are stated in general in Kirk-Othmer, Encyclopedia of Chemical Technology, Fourth Edition, volume 9, and in particular on pages 397-403 and Emulsions: Theory and Practice, 3^{rd} Edition, by Paul Becher, Oxford University Press, (2001).

“Sparging” means the introduction of gas into a liquid for the purpose of creating a plurality of bubbles that migrate up the liquid.

Preferably the surfactant compositions of the present invention are ethylene oxide and 1,4-dioxane free.

Alkyl polyglucosides are complex products made by the reaction of glucose and fatty alcohol. In dealing with the chemistry one talks about degree of polymerization (the so called “d.p.”). In the case of traditional alkyl polyglycosides the d.p. is around 1.4. This means that on average the is 1.4 units of glucose for each alkyl group. The fact of the matter is that the resulting material is a mixture having an average of 1.4.

The specific structure of the product is hard to ascertain completely since many positional isomers are possible, but two examples of structures are as follows:

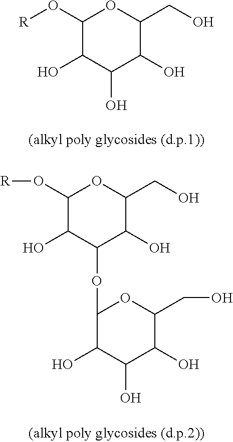

It should be clear that if there is a 50/50 mixture of the d.p. 1 and d.p. 2 product, the resulting analytical data will show that on average there is a d.p. of 1.5. Saying that a molecule has a d.p. of 1.5 does not mean that each molecule has 1.5 glucose units on it.

In one embodiment of the present invention, the surfactant is one that is disclosed in U.S. Pat. No. 6,627,612, incorporated herein by reference; and/or surfactants sold by Colonial Chemical, Inc. under the brand names Suga® Nate and Suga® Fax.

In another embodiment of the present invention, the surfactant is one disclosed in U.S. Pat. No. 6,958,315, incorporated herein by reference; and/or surfactants sold by Colonial Chemical, Inc. under the brand name Suga® Glycinate.

In another embodiment of the present invention, the surfactant is one disclosed in U.S. Pat. No. 8,268,766, incorporated herein by reference; and/or surfactants sold by Colonial Chemical, Inc. under the brand name Poly Suga® Mulse.

In another embodiment of the present invention, the surfactant is one disclosed in U.S. Pat. No. 7,507,399, incorporated herein by reference; and/or surfactant sold by Colonial Chemical, Inc. under the brand names Poly Suga® Quats, PolySuga® Nates, PolySuga® Phos.

In another embodiment of the present invention, the surfactant is one disclosed in U.S. Pat. No. 7,087,571, incorporated herein by reference; and/or surfactants sold by Colonial Chemical, Inc. under the brand name Suga® Mates.

In another embodiment of the present invention, the surfactant is one disclosed in U.S. Pat. No. 7,335,627, incorporated herein by reference; and/or surfactants sold by Colonial Chemical, Inc. under the brand name Poly Suga® Carb.

In another embodiment of the present invention, the surfactant is one that are sugar-based sulfonate-, phosphate-, glycinate-, sulfosuccinate-, and carboxylate-containing surfactants derived from alkyl polyglucosides, including those disclosed in U.S. Pat. Nos. 6,627,612; 6,958,315; 7,087,571; 7,507,399 and 7,335,627.

The surfactants of the present invention may work alone or in combination with nonionic, alkyl polyglucoside-based sorbitan-ester crosspolymers (including those disclosed in U.S. Pat. No. 8,268,766).

The compositions of the present invention include a single embodiment, or mixture, used alone or in combination with an additional embodiment. The additional embodiment can be in the role of a co-surfactant.

Other co-surfactants can be included in the mixtures of the present invention. Examples of the co-surfactants include ionic and nonionic surfactants.

These derivatized alkyl polyglucosides are naturally derived, do not possess polyoxyethylene groups (or contain residual ethylene oxide monomer or 1,4-dioxane), are biodegradable and in many cases have been found to have very low skin and eye irritation.

In one embodiment the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

In another embodiment of the present invention, the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

In another embodiment of the present invention, the surfactant is a sorbitan ester alkylglucoside crosspolymer, more specifically a sorbitan ester oleate decylglucoside crosspolymer.

In another embodiment of the present invention, the surfactant is an alkoxylated alkyl polyglucoside as described in U.S. Pat. No. 6,800,741.

In one embodiment of the present invention, the derivatized polyglucoside surfactant of the present invention comprises a monosaccharide unit, a disaccharide unit, a linker, and a functionalizing agent.

In this regard, a derivatized alkyl polyglucoside composition of the present invention includes the following, as a mixture:

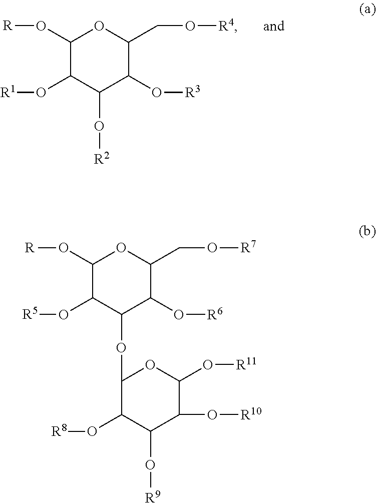

wherein:
R is an alkyl chain having 8 to 22 carbon atoms
R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺

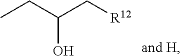

with the proviso that R¹-R¹¹ are not all H;
R¹² is selected from the group consisting of:
—OH, —SO₃⁻M⁺, and —SO₄⁻²M⁺, —O—P(O)—(OM)₂,
—N(CH₃)₂—R^{1A}, —O—C(O)—CH₂—OH(SO₃⁻M⁺)—C(O)—O⁻M⁺,

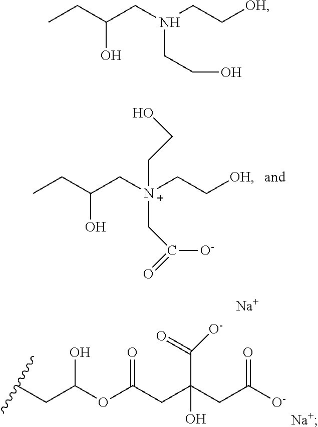

R^{1A} is CH₃—(CH₂)ₙ—;
M is a charge balancing group selected from H, Na, K, or NH₄⁺; and
n is an integer from 0-36;
and positional isomers thereof.

In one embodiment of the present invention, the derivatized polyglucoside surfactant of the present invention comprises a monosaccharide unit, a disaccharide unit, a crosslinking agent, and a functionalizing agent.

In this regard, a derivatized alkyl polyglucoside composition of the present invention includes the following, as a mixture:

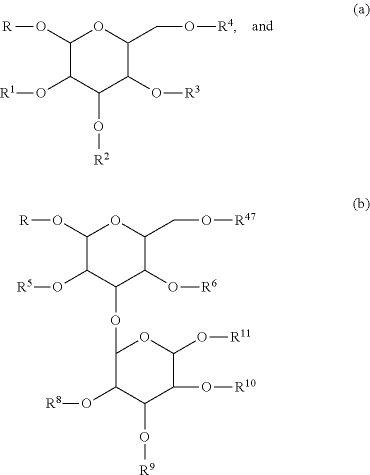

wherein:
R is an alkyl chain having 8 to 22 carbon atoms;
a crosslinking agent; and
a functionalizing agent selected from:

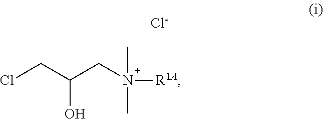

Cl—CH₂—CH(OH)—SO₃M, Cl—CH₂—CH(OH)—SO₄M, Cl—CH₂—CH(OH)—CH₂—OP(O)—(OM)₂, and combinations thereof, wherein
R^{1A} is CH₃(CH₂)ₙ—;
(ii) —Cl—CH₂—C(O)⁻Na⁺, 2-halocarboxylic acid, α, β-unsaturated carboxylic acid, cyclic carboxylic acid anhydride, and combinations thereof,

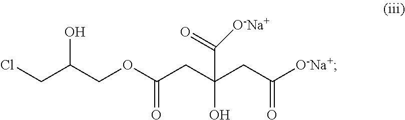

M is a charge balancing group selected from H, Na, K, or NH₄⁺; and
n is an integer from 0-36;
and positional isomers thereof.

Crosslinking agents for the polyfunctionalized alkyl polyglucosides described immediately above include, but are not limited to, 1,3-dichloro-2-propanol and epichlorohydrin.

Thus, in one embodiment the surfactant of the present invention is a phosphate and/or sulfonate functionalized alkyl polyglucoside of the following compounds, as a mixture, are useful as pigments surfactants, wetting agents, and stabilizers:

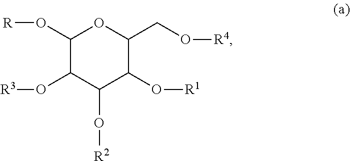

wherein:
R is an alkyl chain having 8 to 22 carbon atoms;
R¹, R², R³, and R⁴ are independently selected from the group consisting of:

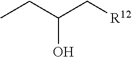

with the proviso that R¹, R², R³, and R⁴ are not all H; R¹² is selected from the group consisting of:
—OH, —SO₃⁻M⁺, —SO₄⁻²M⁺, and —O—P(O)—(OM)₂;
M is selected from the group consisting of Na, K, NH⁴;
and

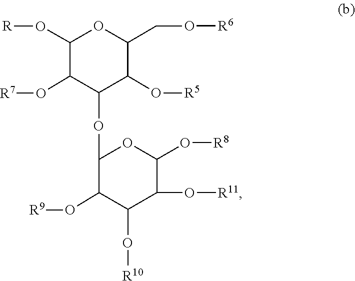

wherein
R⁵, R⁶, R⁷, R⁸, R⁹, R¹⁰, and R¹¹ are independently selected from the group consisting of:

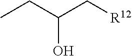

### and H; and

R¹² is selected from the group consisting of:
—OH, —O—P(O)—(OM)₂, —SO₃⁻M⁺, and —SO₄⁻²M⁺, and M is selected from the group consisting of Na, K, NH⁴;
and positional isomers thereof.

These alkyl polyglucoside surfactants are manufactured by Colonial Chemical, Inc., South Pittsburgh, TN 37380. Two examples of which are sodium laurylglucosides hydroxypropylsulfonate (sold under the brand name Suga® Nate 160NC) and sodium decylglucosides hydroxypropylsulfonate (sold under the brand name Suga® Nate 100NC). The alkylpolyglucoside phosphates of the current invention are manufactured by Colonial Chemical, In., South Pittsburgh, TN 37380. An example of which is Sodium Decylglucosides Hydroxypropyl Phosphate, sold under the brand name Suga® Fax D10NC.

These surfactants are synthesized by the methods outlined in U.S. Pat. No. 6,627,612 or their corresponding patents and are generally supplied as clear solutions, 30-50% solids, that are used as pigment or mineral surfactants.

The phosphate functionalized alkyl polyglucoside surfactants of this embodiment are also described in U.S. Pat. No. 8,216,994. Thus, phosphate functionalized alkyl polyglucosides of the present invention include those with the following formula:

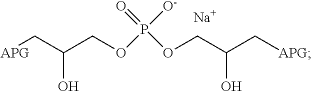

wherein APG is alkyl polyglucoside; and positional isomers thereof. In some embodiments, the alkyl moiety contains about 12 carbon atoms. An example of a suitable phosphate functionalized alkyl polyglucoside includes, but is not limited to, sodium dilaurylglucoside hydroxypropyl phosphate.

The sulfonated functionalized alkyl polyglucoside surfactants of this embodiment are also described in U.S. Pat. No. 8,216,988. Thus, sulfonated functionalized alkyl polyglucosides of the present invention include those with the following formula:

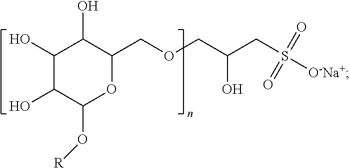

wherein n is between 1 to about 3, and particularly 1.5; and positional isomers thereof. R is an alkyl chain. Examples of suitable sulfonated functionalized alkyl polyglucosides include sodium laurylglucosides hydroxypropyl sulfonate and sodium declyglucosides hydroxypropyl sulfonate and combinations thereof.

An additional embodiment of the present invention is also a glycinate-modified alkylpolyglucoside surfactants represented by compounds of the following formulae, and positional isomers thereof, ae a mixture

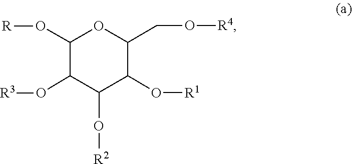

wherein
R is alkyl having 1 to 22 carbon atoms;
R¹, R², R³, and R⁴ are independently selected from

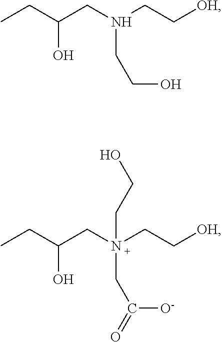

and H, with the proviso that R¹, R², R³, and R⁴ are not all H;
and

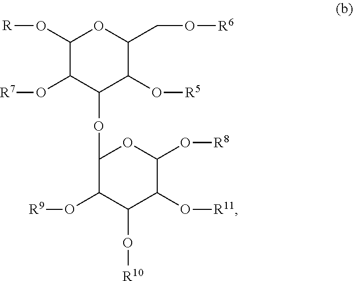

wherein
R is alkyl having 8 to 22 carbon atoms;
R⁵, R⁶, R⁷, R⁸, R⁹, R¹⁰, and R¹¹ are independently selected from

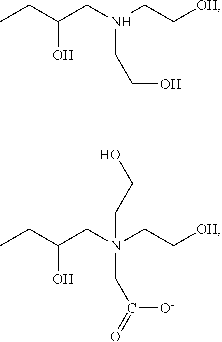

and H, with the proviso that R⁵, R⁶, R⁷, R⁸, R⁹, R¹⁰, and R¹¹ are not all H;
and positional isomers thereof.

The alkylpolyglucoside glycinates of the current invention are manufactured by Colonial Chemical, Inc., South Pittsburgh, TN 37380, two examples of which are Sodium Bis-Hydroxyethylglycinate Coco-Glucosides Crosspolymer (sold under the brand name Poly Suga® Glycinate C) and Sodium Bis-Hydroxyethylglycinate Lauryl-Glucosides Crosspolymer (sold under the brand name Poly Suga® Glycinate L).

These surfactants are synthesized by the methods outlined in U.S. Pat. No. 6,958,315 and are generally supplied as clear solutions, 30-50% solids, that are used as pigment or mineral surfactants.

An embodiment of the present invention is also crosspolymers of alkylpolyglucosides and sorbitan esters as sugar-based nonionic surfactants, represented as compounds of the following formulae, and positional isomers thereof, as a mixture:

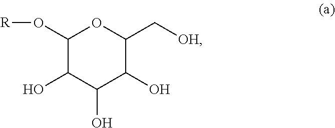

wherein;
R is alkyl having 8 to 22 carbon atoms; and

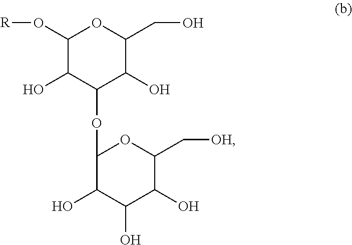

wherein:
R is alkyl having 8 to 22 carbon atoms; and
(c) a sorbitan ester of the following structure:

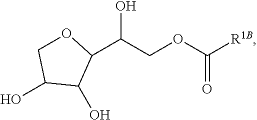

wherein:
R^{1B} is alkyl having 7 to 21 carbons;
a crosslinking agent of the following structure:

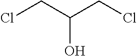

in water; and
optionally a functionalizing agent selected from the group of:

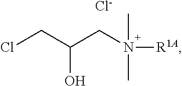

Cl—CH₂—CH(OH)SO₃M, Cl—CH₂—CH(OH)SO₄M,
Cl—CH₂—CH(OH)CH₂—OP(O)—(OM)₂, and mixtures thereof;
   wherein R^{1A} is CH₃ (CH₂)ₙ—,
   n is an integer from 0 to 36;
   M is a charge balancing group selected from H, Na, K, or NH₄;
   and positional isomers thereof.

The crosspolymers of alkylpolyglucosides and sorbitan esters that are the sugar-based nonionic surfactants of the current invention are manufactured by Colonial Chemical, Inc., South Pittsburgh, TN 37380, two examples of which are Poly Suga® Mulse D6 and Poly Suga® Mulse D9, both described as sorbitan oleate decylglucoside crosspolymer.

These surfactants are synthesized by the methods outlined in U.S. Pat. No. 8,268,766. The ratio of alkyl polyglucoside monomer to sorbitan ester monomer in the cross polymers can vary from 20:1 to 1:1, respectively.

An embodiment of the present invention is also sulfonate-modified, phosphate-modified and cationically modified poly-sugar alkyl polyglucoside surfactants, represented by compounds of the following formulae, as a mixture:

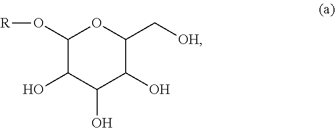

wherein;
R is alkyl having 8 to 22 carbon atoms; and

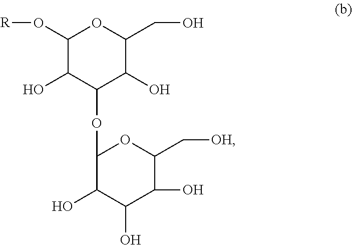

wherein:
R is alkyl having 8 to 22 carbon atoms;
a crosslinker of the following formula: Cl—CH₂—CH(OH)—CH₂—Cl; and
a functionalizing agent selected from:

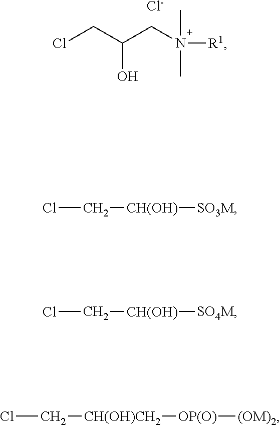

and mixtures thereof;
wherein R¹ is CH₃ (CH₂)ₙ—;
n is an integer from 0 to 36;
M is a charge balancing group selected from H, Na, K, or NH₄;
and positional isomers thereof.

These alkyl polyglucosides of the current invention are manufactured by Colonial Chemical, Inc., South Pittsburgh, TN 37380, as shown in U.S. Pat. No. 7,507,399. Examples of these alkyl polyglucosides are: sodium hydroxypropyl phosphate decylglucoside crosspolymer (Poly Suga® Phos 1000P), sodium hydroxypropyl phosphate laurylglucoside crosspolymer (PolySuga® Phos 1200P), Sodium hydroxypropyl phosphate cocoglucoside crosspolymer (PolySuga® Phos 8600P), Sodium hydroxypropyl sulfonate butylglucoside crosspolymer (PolySuga® Nate 40P), Sodium hydroxypropyl sulfonate decylglucoside crosspolymer (PolySuga® Nate 100P), Sodium hydroxypropyl sulfonate laurylglucoside crosspolymer (PolySuga® Nate 160P NC), Polyquaternium-78 (Poly Suga® Quat L-1010P), Polyquaternium-80 (Poly Suga® Quat L-1210P) and Polyquaternium-81 (Poly Suga® Quat S-1201P).

Another description of this embodiment is described in U.S. Pat. No. 8,329,633. Thus, poly quaternary functionalized alkyl polyglucosides of the present invention have the following formula:

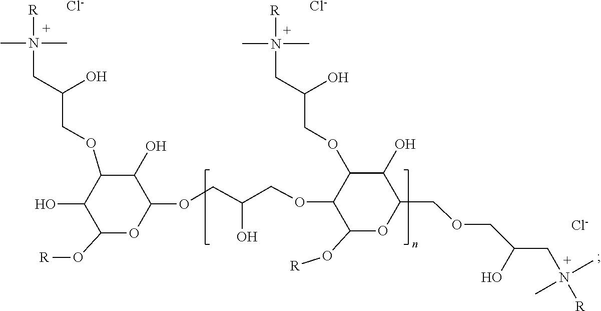

wherein R is an alkyl group having from about 8 to about 22 carbon atoms and n is an integer ranging from 4 to 6; and positional isomers thereof.

Another description of this embodiment is described in U.S. Pat. No. 8,262,805. Thus, poly sulfonate functionalized alkyl polyglucosides of the present invention have the following formula:

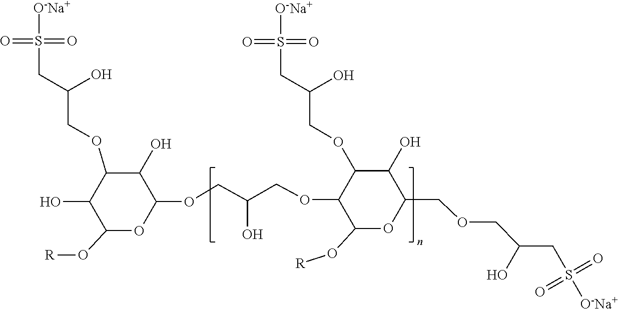

wherein R is an alkyl group having from about 8 to about 22 carbon atoms and n is an integer ranging from 4 to 6; and positional isomers thereof.

Another example of this embodiment is described in U.S. Pat. No. 8,287,659. That is, polyphosphate functionalized alkyl polyglucosides of the following formula:

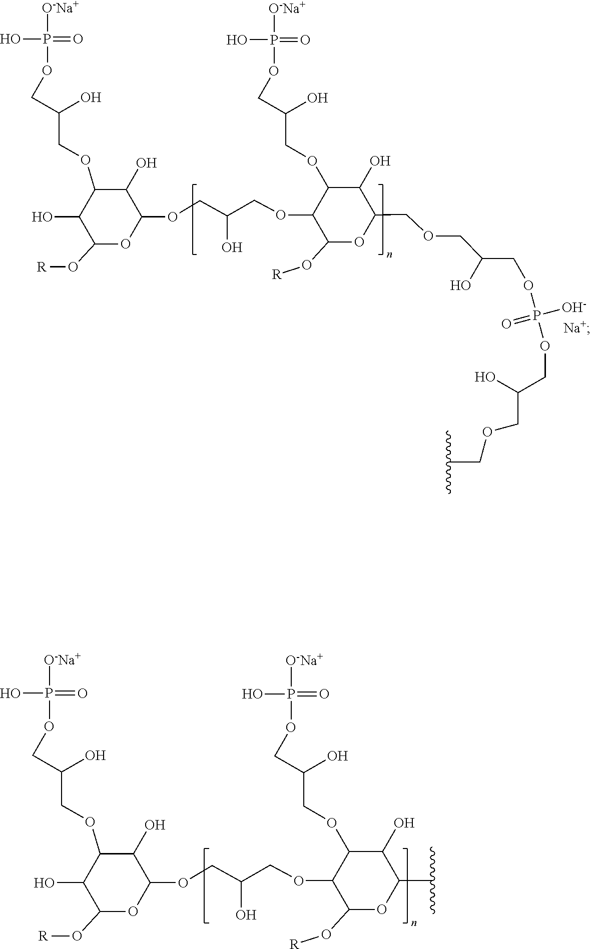

wherein R is an alkyl group having from about 8 to about 22 carbon atoms; and positional isomers thereof.

Another surfactant of the present invention is also described in U.S. Pat. Nos. 8,557,760 and 8,389,457. Quaternary functionalized alkyl polyglucosides of the present invention may have the following representative formula:

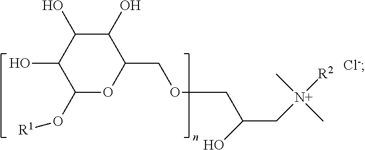

wherein R¹ is an alkyl group having from about 8 to about 22 carbon atoms, and R² is CH₃(CH₂)ₙ, and n is independently an integer from 0-21; and positional isomers thereof. Examples of suitable quaternary functionalized alkyl polyglucosides surfactants include those in the R¹ alkyl moiety contains primarily about 12 carbons, the R² group is CH₃.

Embodiments of the present invention are also sulfosuccinate-modified, alkylpolyglucoside surfactants, represented by compounds of the following formulae, as a mixture:

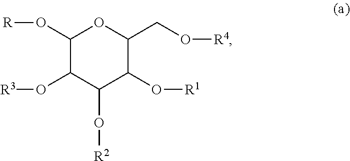

wherein
R is alkyl having 8 to 22 carbon atoms;
R¹, R², R³, and R⁴ are independently selected from —CH₂—CH(OH)—CH₂—R¹², and H, with the proviso that R¹, R², R³, and R⁴ are not all H;
R¹² is —O—C(O)—CH₂—CH(SO₃ M⁺)—C(O)—O⁻ M⁺
M is a charge balancing group selected from H, Na, K, or NH₄;
and

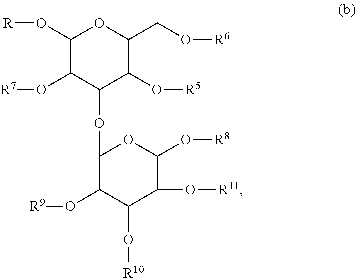

wherein
R is alkyl having 8 to 22 carbon atoms;
R⁵, R⁶, R⁷, R⁸, R⁹, R¹⁰, and R¹¹ are independently selected from —CH₂—CH(OH)—CH₂—R¹², and H,
with the proviso that R⁵, R⁶, R⁷, R⁸, R⁹, R¹⁰, and R¹¹ are not all H;
R¹² is —O—C(O)—CH₂—CH(SO₃ M⁺)—C(O)—O⁻ M⁺
M is a charge balancing group selected from H, Na, K, or NH₄;
and positional isomers thereof.

The sulfosuccinate-modified PolySuga® alkylpolyglucosides of the current invention are manufactured by Colonial Chemical, Inc., South Pittsburgh, TN 37380. These surfactants are synthesized by the methods outlined in U.S. Pat. No. 7,087,571 and are generally supplied as clear solutions, 30-50% solids, that are used as pigment or mineral surfactants.

Another embodiment of the present invention is carboxymethyl-modified, Poly Suga®-alkylpolyglucoside surfactants, represented by the following components, as a mixture:

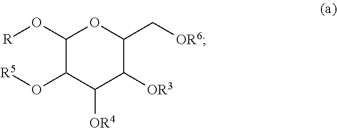

wherein one of R³, R⁴, R⁵, and R⁶ is —CH₂—C(O)—O⁻ M⁺ or —C(O)—CH₂—C(O)—O⁻ M⁺, with the remaining R groups being H; R is alkyl having 6 to 30 carbon atoms; M is H, Na, or K; and
(b) a 1,3 dicloloro-2-propanol crosslinker;
and positional isomers thereof.

The carboxymethyl-modified Poly Suga® alkyl polyglucosides of the current invention are manufactured by Colonial Chemical, Inc., South Pittsburgh, TN 37380, examples of which are Sodium Maleate Decylglucoside Crosspolymer (Poly Suga® Carb DM), Sodium Maleate Laurylglucoside Crosspolymer (Poly Suga® Carb LM) and Sodium Succinate Laurylglucoside Crosspolymer (Poly Suga® Carb LS).

These surfactants are synthesized by the methods outlined in U.S. Pat. No. 7,335,627 and are generally supplied as clear solutions, 40-60% solids, that are used as pigment surfactants.

Another embodiment of the present invention is a citrate-functionalized polymeric alkylglucoside surfactant, represented by the following components, as a mixture:

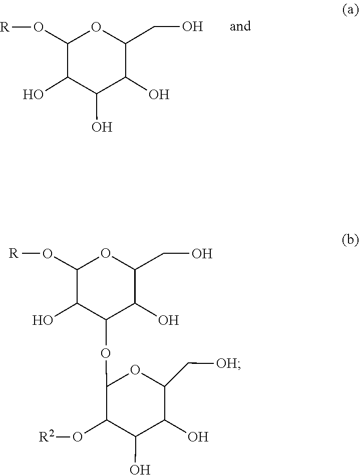

wherein R is an alkyl having 8 to 22 carbons, and R² is:

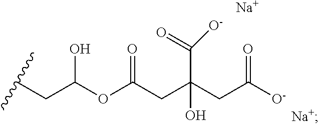

and positional isomers thereof. The citrate-modified alkyl polyglucosides of the current invention are manufactured by Colonial Chemical, Inc., South Pittsburgh, TN 37380, an example of which is Disodium Laurylglucosides Hydroxypropyl Citrate (Suga® Citrate L1C)

The functionalized alkylpolyglucosides of the present invention have found wide application mostly in the personal care market in various cleansing products such as shampoos, body washes and facial washes. Additionally, their use in household, industrial and institutional cleaning has been the subject of a number of patents. The Suga® Quats and Poly Suga® Quats surfactants mentioned above have been patented for use in various hard-surface cleaning applications (outlined in U.S. Pat. Nos. 8,557,760; 8,389,457; 8,329,633; 8,877,703; 10,035,975; and U.S. Pat. No. 9,474,703 issued to Ecolab USA Inc.). The Suga® Nate and Poly Suga® Nate surfactants mentioned above have also been patented for use in various hard-surface cleaning applications (U.S. Pat. Nos. 8,071,520; 8,216,988; and U.S. Pat. No. 8,262,805 issued to Ecolab USA Inc.). The Poly Suga® Glycinates mentioned above have also been patented for use in various hard-surface cleaning applications (U.S. Pat. No. 8,299,099 issued to Ecolab USA Inc.). The Suga® Fax and Poly Suga® Fax surfactants mentioned above have also been patented for use in various hard-surface cleaning applications (U.S. Pat. Nos. 8,216,994; 8,287,659; and U.S. Pat. No. 8,969,285 issued to Ecolab USA Inc.). The Poly Suga® Mates surfactants mentioned above have been patented for use in various hard-surface cleaning applications of (8,658,584 issued to Ecolab USA Inc.).

As stated above, the present inventors have found the surfactants of the present invention, and combinations thereof, to be useful and beneficial as part of an agent used in a mineral beneficiation process. One example is a use as a composition for improving a froth flotation type separation as described in U.S. Pat. No. 9,440,242. As described for example in U.S. Pat. Nos. 4,756,823, 5,304,317, 5,379,902, 7,553,984, 6,827,220, 8,093,303, 8,123,042, and in Published US Patent Applications 2010/0181520 A1 and 2011/0198296, and U.S. patent application Ser. No. 13/687,042, one form of beneficiation is froth flotation separation. Commonly, flotation uses the difference in the hydrophobicity of the respective components. The components are introduced into the flotation apparatus sparged with air, to form bubbles. The hydrophobic particles preferentially attach to the bubbles, buoying them to the top of the apparatus. The floated particles (the concentrate) are collected, dewatered and accumulated as a sellable product. The less hydrophobic particles (the tailings) tend to migrate to the bottom of the apparatus from where they can be removed.

The performance of collectors can be enhanced by the use of modifiers. Modifiers may either increase the adsorption of collector onto a given mineral (promoters), or prevent collector from adsorbing onto a mineral (depressants). Promoters are a wide variety of chemicals which in one or more ways enhance the effectiveness of collectors. One way promoters work is by enhancing the dispersion of the collector within the slurry. Another way is by increasing the adhesive force between the concentrate and the bubbles. A third way is by increasing the selectivity of what adheres to the bubbles. This can be achieved by increasing the hydrophilic properties of materials selected to remain within the slurry, these are commonly referred to as depressants.

Frothing agents or frothers are chemicals added to the process which have the ability to change the surface tension of a liquid such that the properties of the sparging bubbles are modified. Frothers may act to stabilize air bubbles so that they will remain well-dispersed in slurry, and will form a stable froth layer that can be removed before the bubbles burst. Ideally the frother should not enhance the flotation of unwanted material and the froth should have the tendency to break down when removed from the flotation apparatus. Collectors are typically added before frothers and they both need to be such that they do not chemically interfere with each other. Commonly used frothers include pine oil, aliphatic alcohols such as MIBC (methyl isobutyl carbinol), polyglycols, polygloycol ethers, polypropylene glycol ethers, polyoxyparafins, cresylic acid (Xylenol), commercially available alcohol blends such as those produced from the production of 2-ethylhexanol and any combination thereof.

The froth must be strong enough to support the weight of the mineral floated and yet not be tenacious and non-flowing. The effectiveness of a frother is dependent also on the nature of the fluid in which the flotation process is conducted. Unfortunately contradictory principles of chemistry are at work in froth flotation separation which forces difficulties on such interactions. Because froth flotation separation relies on separation between more hydrophobic and more hydrophilic particles, the slurry medium often includes water. Because however many commonly used frothers are themselves sparingly soluble in water if at they do not disperse well in water which makes their interactions with the bubbles less than optimal.

The surfactants of the present invention enhance the performance of frothing agents in a froth flotation separation of slurry in a medium. This method may include the steps of: making a stable microemulsion with a frothing agent, a surfactant (optionally also with a cosurfactant) and water, and blending this microemulsion with the medium, tines, and other additives, and removing concentrate from the slurry by sparging the slurry.

Accordingly, in this regard, at least one embodiment of the invention is directed to a method of enhancing the performance of frothing agent in a froth flotation separation of slurry in a medium. The method comprises the steps of: making stable microemulsion with a frothing agent, a surfactant of the present invention (optionally also with a cosurfactant) and water, and blending this microemulsion with the medium, tines, and other additives, and removing concentrate from the slurry by sparging the slurry.

The microemulsion may improve the efficiency of froth separation process. More concentrate may be removed than if a greater amount of frother had been used in a non-microemulsion form. The microemulsion may comprise a continuous phase which is water and a dispersed phase. The microemulsion as a whole by weight may be made up of: 1-99% water, blended with: 1-50% of a frother component such as an alcohol blend which is from the waste stream of the production of 2-ethyl hexanol, 1-15% C₈-C₁₀ fatty acids, 1-30% surfactant of the present invention, 1-20% propylene glycol, and 1-10% potassium hydroxide.

The microemulsion as a whole by weight may be made up of: 1-99% water, blended with: 1-50% of a frother component such as an alcohol blend which is from the waste stream of the production of 2-ethyl hexanol, 1-20% C₈-C₁₀ fatty, acids, 1-30% surfactant of the present invention, and 1-10% potassium hydroxide.

The microemulsion as a whole by weight may be made up of: 1-99% water, 1-50% of a frother component such as an alcohol blend which is from the waste stream of the production of 2-ethyl hexanol, 1-30% 2-ethyl hexanoic acid, 1-20% surfactant of the invention, and 1-10% potassium hydroxide.

In at least one embodiment the composition added to the slurry contains one or more materials or is added according to one or more of the processes described in one or more of: Canadian Patent Application CA 2150216 A1. United Kingdom Patent Application GB 2171929 A, and The use of reagents in coal flotation, by Laskowski, J. S.; et al, Processing of Hydrophobic Minerals and Fine Coal, Proceedings of the UBC-McGill Bi-Annual International Symposium on Fundamentals of Mineral Processing, 1st, Vancouver, B. C., Aug. 20-24, 1995 (1995), pp. 191-197.

In at least one embodiment the dosage range for the microemulsion frother in the slurry would be >0-100 ppm of active frother.

In at least one embodiment the microemulsion is applied to anyone or more of the following processes: beneficiation of ore containing: copper, gold, silver, iron, lead, nickel, cobalt, platinum, zinc, coal, barite, calamine, fledspar, fluorite, heavy metal oxides, talc, potash, phosphate, iron, graphite, kaolin clay, bauxite, pyrite, mica, quartz, and any combination thereof, sulfide ores including but not limited to copper, gold and silver, iron, lead, nickel and cobalt, platinum, zinc, complex sulfide ores such as but not limited to copper-lead-zinc, non-sulfide ores such as coal, barite, calamine, fledspar, fluorite, heavy metal oxides, talc, potash, phosphate, iron, graphite and kaolin clay, and any combination thereof.

In at least one embodiment the microemulsions form spontaneously, when the components are brought together. Provided the components are in the correct proportion, the mixture may be optically clear and/or may be thermodynamically stable. Thus, their manufacturing may be reduced to simple kneading without the need for expensive high energy mixing. Also, often microemulsions are not prone to separation or settling, which may result in their long storage stability. In at least one embodiment only gentle mixing is required to restore a microemulsion if it has been previously frozen.

Representative frothers useful in the invention include but are not limited to aliphatic alcohols, cyclic alcohols, propylene oxide and polypropylene oxide, propylene glycol, polypropylene glycol and polypropylene glycol ethers, polyglycol ethers, polyglycol glycerol ethers, polyoxyparrafins, natural oils such as pine oil an alcohol blend which is from the waste stream of the production of 2-ethyl hexanol and any combination thereof.

In at least one embodiment the microemulsion is an oil-in water type microemulsion.

In at least one embodiment the microemulsion is a water-in oil type microemulsion.

In at least one embodiment the microemulsion is one or more of a: Winsor type I microemulsion, Winsor type II microemulsion, Winsor type III microemulsion, and any combination thereof.

The composition may be used along with or in the absence of a collector. It may be added to the slurry before, after, or simultaneous to the addition of a collector. It may be added before during or after sparging and/or beneficiation has begun. The composition may be used with or in the absence of any collector in any flotation process.

When used along with a collector, the collector may comprise at least one of the collector compositions and/or other compositions described in scientific papers: Application research on emulsive collector for coal flotation, by CL. Han et al., Xuanmei Jishu, vol. 3 pages 4-6 (2005). The use of reagents in coal flotation, by J. S. Laskowski, Proceedings of the UBC-McGill Bi-Annual International Symposium on Fundamentals of Mineral Processing, Vancouver, BC, CIMM, Aug. 20-24 (1995), Effect of collector emulsification on coal flotation kinetics and on recovery of different particle sizes, by A. M. Saleh, Mineral Processing on the verge of the 21st Century, Proceedings of the International Mineral Processing Symposium, 8th Antalya, Turkey, Oct. 16-18, 2000, pp. 391-396 (2000), Application of novel emulsified flotation reagent in coal slime floatation, by W. W. Xie, Xuanmei Jishu vol. 2 pp. 13-15 (2007). A study of surfactant oil emulsions for fine coal flotation, by Q. Yu et al., Advance in Fine Particle Processing, Proc. Int. Symp. pp. 345-355, (1990), and Evaluation of neiv emulsified floatation reagent for coal, by S. Q. Zhu, Science Press Beijing, vol. 2 pp. 1943-1950 (2008).

In at least one embodiment at least part of the collector is at least one item selected from the list consisting of: fatty acids, fatty acid esters, neutralized fatty acids, soaps, amine compounds, petroleum-based oily compounds (such as diesel fuels, decant oils, and light cycle oils, kerosene or fuel oils), organic type collector, and any combination thereof.

In at least one embodiment the organic type collector is a sulfur containing material which includes such items as xanthates, xanthogen formates, thionocarbamates, dithiophosphates (including sodium, zinc and other salts of dithiophosphates), and mercaptans (including mercaptobenzothiazole), ethyl octylsulfide, and any combination thereof.

In at least one embodiment the collector includes “extender oil” in which at least one second collector is used to reduce the required dosage of at least one other more expensive collector.

Another embodiment is the use of the surfactants of the present invention to improve a leaching process, such as the one described in U.S. patent Ser. No. 10/344,353. Generally, this process involves a method of separating metal from a metalliferous material by treating a ground or crushed material with a chemical solution containing one or more reagents that are capable of selectively dissolving a desired metal component while leaving the remainder of the metalliferous material. The leach solution may then be treated in further recovery and refining operations to obtain the metal values in purified form. The method may include forming a slurry comprising a metal-containing material, water, a surfactant composition using a surfactant of the present invention, and a leaching composition; then recovering at least a portion of the metal from the slurry.

Thus, an example of this process includes a method of extracting a metal from a metal-containing ore, that includes applying a surfactant composition of the present invention, and a leaching agent to the raw ore material to form a treated raw ore; subjecting the treated raw ore to a leaching process; and recovering at least a portion of the metal. A method of extracting metal from a metal-bearing material is provided. The method comprises forming a slurry comprising the metal-bearing material, water, a surfactant composition, and a leaching composition. At least a portion of the metal from the slurry is recovered

Accordingly, an embodiment of the present invention is a method of improving leaching efficiency in a metal extraction process. The method comprises treating a metal-bearing material with a surfactant composition. The treated metal-bearing material is subjected to a metal extraction process.

In an example of this embodiment, a slurry is provided. The slurry comprises water; a metal-bearing material comprising at least one of gold, silver, and copper; a high terpene-containing natural oil; and a leaching agent comprising at least one of an acid and a cyanide.

The metal-bearing material may be comminuted prior to formation of the slurry. The metal-bearing material may be treated with the surfactant composition prior to, during, or after comminution. The comminuted metal-bearing material may be formulated as an aqueous slurry including the comminuted metal-bearing material.

The surfactant composition may include at least one surfactant of the present invention. Thus examples of the surfactant include at least one derivatized carbohydrate selected from an alkyl derivatized polyglycosides, glycolipid, glycerol glycolipid, sphingo glycolipid, sulfolipid, phospholipid, glucoside, rhamnolipid, sophrolipid; at least one crosspolymer of an alkyl polyglucoside; at least one derivatized alkyl polyglucoside, and/or an alkyl polyglucoside sorbitan ester crosspolymer; or combinations thereof.

The surfactant composition may be present in the slurry at a concentration of from about 1 gram of surfactant composition to about 10,000 grams of surfactant composition per metric ton of metal-bearing material. The surfactant composition may be present in the slurry at a concentration of from about 10 grams of surfactant composition to about 100 grams of surfactant composition per metric ton of metal-bearing material.

The leaching composition may include a leaching agent selected from the group consisting of nitric acid, hydrofluoric acid, hydrochloric acid, sulfuric acid, phosphoric acid, perchloric acid, a carbonate, a hydroxide base, gaseous ammonia, a cyanide salt, ferric sulfate, ferric chloride, cupric chloride, ferrous chloride, ozone, a thiosulfate salt, thiourea, thiosulfuric acid, dithiooxamide, a substituted dithiooxamide, a halogen-containing compound, and combinations thereof. The leaching agent may be at least one of sodium cyanide, potassium cyanide, and calcium cyanide.

Examples of the recovered metal include gold, silver, platinum, palladium, titanium, or nickel.

The metal-bearing material may be ore.

The metal-bearing material may be treated with the leaching composition in a stirred reactor.

In another aspect of this embodiment, the present invention includes a method of improving leaching efficiency in a metal extraction process, the method including treating a metal-bearing material with a surfactant composition; and subjecting the treated metal-bearing material to a metal extraction process. The metal-bearing material may be comminuted before or during treatment with a surfactant composition of the present invention. The extraction process may include at least one of in-situ leaching, dump leaching, heap leaching, vat leaching, agitated leaching, and combinations thereof.

Accordingly, one of ordinary skill in the art would recognize that methods disclosed herein improve extraction of metal from a metal-bearing material. The methods include treating a metal-bearing material with a surfactant composition of the present invention, and leaching a metal from the treated metal-bearing material. The metal-bearing material may be treated with the surfactant composition at any suitable point in the extraction process. In certain embodiments, the surfactant composition improves leaching of metal from metal-bearing material. While not wishing to be bound by theory, it is believed that the surfactant composition reduces surface tension of leaching agent solutions at particle surfaces of the metal-bearing material. The reduced surface tension is believed to allow for increased exposure of metal-bearing particle surfaces to the leaching agents added during the extraction process, which in turn is believed to allow for greater dissolution and/or chemical reaction of the metal with the leaching agent(s).

The methods provide several advantages over current technologies. In particular, the methods can improve leaching efficiency and metal recovery from metal-bearing materials. The methods can be implemented into current extraction processes with minimal capital investment, using equipment already in place.

Disclosed are methods of improving leaching efficiency from metal-bearing material in extractive metallurgy processes. The methods include treating the metal-bearing material (e.g., an ore material) with a surfactant composition. The metal-bearing material may be treated with the surfactant composition of the present invention at any suitable point in an extraction process, preferably before and/or during treatment with a leaching composition. The surfactant composition can be added to a raw metal-bearing material (e.g., raw ore material), a crushed metal-bearing material, a ground/milled metal-bearing material, and/or a slurry of metal-bearing material. The surfactant composition can be applied to a metal-bearing material during pre-leaching processes (e.g., during transport, during crushing, grinding, mixing, or during blending into a slurry). The surfactant composition can be combined with one or more compositions, before or during application to a metal-bearing material. The surfactant composition can be combined with a leaching composition and applied concurrently to a metal-bearing material.

In certain embodiments, the methods include treating a raw ore material with a surfactant composition, comminuting the treated ore material (e.g., wet or dry crushing and/or wet or dry grinding), and leaching one or more selected metals from the comminuted, treated ore material. In certain embodiments, the methods include treating a comminuted ore material with a surfactant composition, and leaching one or more selected metals from the comminuted, treated ore material. In certain embodiments, the methods include treating a slurry of comminuted ore material with a surfactant composition, and leaching one or more selected metals from the treated slurry of ore material. In certain embodiments, the methods include treating a comminuted ore material with a composition including a surfactant composition and a leaching composition, and leaching one or more selected metals from the comminuted, treated ore material.

The disclosed methods, using the surfactants of the present invention, improve metal recovery rates.

The surfactant composition may further comprise a variety of additives such as, for example, an antioxidant and/or a preservative. An example of a suitable antioxidant is butylated hydroxytoluene (i.e., 2,6-di-tert-butyl-para-cresol; “BHT”). The antioxidant may be present in the composition in an amount of from about 0.01% to about 1% by weight, preferably from about 0.08% to about 0.12% by weight. Suitable preservatives include, but are not limited to, formaldehyde, methylparaben, propylparaben, borax, and combinations thereof. The preservative may be present in the composition in an amount of from about 0.5% to about 5% by weight, preferably from about 0.8% to about 1.2% by weight.

The surfactant composition may be dosed to the metal-bearing material in an amount of from about 1 part per million (ppm) to about 10,000 ppm, including from about 1 ppm, or from about 5 ppm, or from about 10 ppm, or from about 15 ppm, or from about 20 ppm, to about 10,000 ppm, or to about 1,000 ppm, or to about 500 ppm, or to about 100 ppm, or to about 50 ppm, or to about 40 ppm. In a preferred embodiment, the surfactant composition is dosed to the metal-bearing material in an amount of from about 20 ppm to about 40 ppm. Referring to the dosage of the surfactant composition, the term “part(s) per million” (i.e., “ppm”) refers to grams of surfactant per metric ton of metal-bearing material (e.g., ore) treated. The surfactant composition may be dosed to the metal-bearing material in an amount of about 1 ppm or greater, or about 5 ppm or greater, or about 10 ppm or greater, or about 15 ppm or greater, or about 20 ppm or greater, or about 25 ppm or greater, or about 30 ppm or greater, or about 35 ppm or greater, or about 40 ppm or greater, or about 45 ppm or greater, or about 50 ppm or greater. Dosages are based upon total surfactant composition in the metal-bearing material.

The disclosed methods may be used with any type of leaching composition suitable for extraction processes. The leaching composition is combined at some point during the surfactant exposure to extract metal from the metal-bearing material, wherein leaching efficiency may be enhanced due to less surface tension created by activity of the surfactant composition. Leaching compositions include at least one leaching agent, e.g., an acid, a base, or a salt. It is to be understood that one or more leaching agents may be used in combination. The leaching composition may further include an additive, which may be a solvent.

Suitable additives that may be utilized in the leaching composition include, but are not limited to, an oxidant and a chelating agent.

A chelating agent may be utilized to sequester a desired metal for metal recovery. In certain embodiments, a chelating agent is added to sequester a metal material that may interfere with leaching and recovery of one or more desired metals. For example, a chelating agent may be added to sequester calcium, magnesium, or other alkaline earth metal ions in an aqueous phase of a metal-bearing slurry. The addition of a chelating agent has been found to improve, for example, gold recovery in some ores.

Examples of chelating or sequestering agents which may be used include, but are not limited to, ethylenediaminetetraacetic acid, nitrilotriacetic acid, diethylenetriaminepentacetic acid, methanediphosphonic acid, dimethylaminomethane-1,1 diphosphonic acid, aminotrimethylenetriphosphonic acid, sodium hexamethaphosphate, 1-hydroxyethane-1,I diphosphonic acid, and salts thereof. The amount of chelating agent added may vary depending on, for example, compositional makeup of the metal-bearing material. A chelating agent may be added in an amount of from about 0.04 to about 2 pounds of chelating agent per ton of metal-bearing material (e.g., ore), or from about 0.8 to about 1.4 pounds of chelating agent per ton of metal-bearing material.

Suitable solvents for inclusion in the leaching composition include, but are not limited to, water. Any suitable source of water for the aqueous leaching compositions may be used. For example, the water may be derived from fresh water, sea water, brine, mixtures of water and non-toxic water soluble organic compounds, recycled process water, or any combination thereof.

The leaching compositions may be applied to the metal-bearing material in an amount sufficient to leach at least a portion of the metal contained in the metal-bearing material, depending on several factors including, but not limited to, the amount of metal-bearing material, the surface area of the metal-bearing material, the concentration of metal in the metal-bearing material, the concentration of leaching composition, the equipment available to perform the leaching, and so forth. A person of skill in the art is able to determine the sufficient amount of leaching composition without undue experimentation.

Exemplary leaching agents/compositions are provided in U.S. Pat. No. 10,344,353.

These disclosed methods may be used with any type of metal-bearing material, such as an ore material, a concentrate, a precipitate, or any other metal-bearing material from which a metal value may be recovered. The metal-bearing material may be an oxide ore, a sulfide ore, or a combination of oxide and sulfide ores. The minerals in the ore material may include a range of oxides, hydroxides, and sulfides. Metals that may be extracted from the metal-bearing materials include, but are not limited to, gold, silver, platinum, rhodium, iridium, osmium, palladium, aluminum, indium, gallium, tellurium, mercury, bismuth, cadmium, lead, zinc, copper, nickel, cobalt, molybdenum, rhenium, ruthenium, germanium, beryllium, iron, uranium, yttrium, titanium, lanthanum, cerium, praseodymium, neodymium, promethium, samarium, europium, gadolinium, terbium, dysprosium, holmium, erbium, thulium, ytterbium, lutetium, and combinations thereof. In a preferred embodiment, the metals that are being extracted from the metal-bearing materials comprise at least one of gold, silver and copper.

The disclosed methods may be used with any type of extractive metallurgy. Extractive metallurgy includes the process of extracting metals from metal-bearing materials (e.g., mineral ores) by physical and/or chemical methods Extractive metallurgy includes hydrometallurgy, pyrometallurgy, and electrometallurgy. Hydrometallurgy is the technique of extracting metals by aqueous physicochemical processes; pyrometallurgy involves dry physicochemical processes at elevated temperatures; and electrometallurgy deals with electrolytic methods. Electrometallurgy may be integrated with the other two processes, with electrolysis in aqueous media being used in hydrometallurgy, and electrolysis in smelted media being used in pyrometallurgy.

Leaching of metal-bearing materials can be accomplished by affecting contact between a metal-bearing material and a leaching composition. The pregnant solution resulting from the leaching process can contain dissolved metals (for example, indium, silver, gold, copper, zinc, lead, gallium, the like, or a combination thereof), residual leaching agents, and/or other materials. The soluble ions or metallic complexes in the pregnant solution can be selectively extracted from the pregnant leaching solution in downstream purification/extraction stages Such purification/extraction stages may include, for example, solvent extraction, filtering, centrifuging, electrolysis, electrowinning, precipitation, ion exchange, and/or flotation.

Leaching processes that may be used for recovery of metal values from metal-bearing materials generally include in-situ leaching, dump leaching, heap leaching, vat leaching, agitated leaching, or a combination thereof. Selection of the type of leaching process to be employed may be based on several factors, such as for example, the grade of an ore material, the clay content of an ore material, the hardness of an are material, or the way an ore material responds to various leaching methods.

As an example of this embodiment, a gold containing ore can be treated with 20 ppm and 40 ppm of a surfactant composition of the present invention comprising 17% surfactant; about 1% cold pressed orange peel oil; about 0.6% cocodiethanolamide; and about 0.13% antioxidant; with the balance being water (all percentages are by weight). The surfactant blend product can be added to a gold containing ore treated with cyanide and evaluated using a standard bottle roll test. Bottle roll tests can be conducted with varied doses from at 0 ppm, 20 ppm, and 40 ppm. The amount of gold extracted in the treated samples is higher when compared to the untreated samples. The surfactants can be applied to metal-bearing materials containing, e.g., any high valuable metal such as, e.g., gold, silver, and copper.

The invention thus being described, it would be understood to those of ordinary skill in the art that various changes in and from details may be made therein without departing from the scope of the invention disclosed herein.

1. A composition for use as a collector, leaching aid, sequestrant or chelant, comprising one or more of the following:
a. at least one derivatized carbohydrate selected from an alkyl derivatized polyglycosides, glycolipid, glycerol glycolipid, sphingo glycolipid, sulfolipid, phospholipid, glucoside, rhamnolipid, sophrolipid;
b. at least one crosspolymer of an alkyl polyglucoside;
c. at least one derivatized alkyl polyglucoside, and/or an alkyl polyglucoside sorbitan ester crosspolymer;
d. at least one of the (a)-(d) further combined with more traditional beneficiation reagents such as xanthates, fatty acids, depressants, frothers, pH modifiers.

2. The composition of claim 1, wherein the surfactant is a collector, leaching aid, sequestrant or chelant for minerals selected from apatite, fluorapatite, silica, calcium carbonate, calcium sulfate, feldspar, barite, magnesite, bauxite, hematite, and kaolinite.

3. The composition of claim 1, wherein the surfactant is a collector, leaching aid, sequestrant or chelant for the following metals including, but not limited to, the all mineral variations of copper, gold, and nickel.

4. The composition of claim 1, wherein the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

5. The composition of claim 1, wherein the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

6. The composition of claim 1, wherein the alkyl polyglucoside crosspolymer is a sorbitan ester alkylglucoside crosspolymer including sorbitan oleate decylglucoside crosspolymer.

7. The composition of claim 1, wherein the derivatized polyglucoside surfactant of the present invention comprises a monosaccharide unit, a disaccharide unit, a linker, and a functionalizing agent.

8. The composition of claim 1, wherein the derivatized polyglucoside surfactant of the present invention comprises a monosaccharide unit, a disaccharide unit, a crosslinking agent, and a functionalizing agent.

9. The composition of claim 1, wherein the derivatized alkyl polyglucoside surfactant is a composition that includes the following, as a mixture: 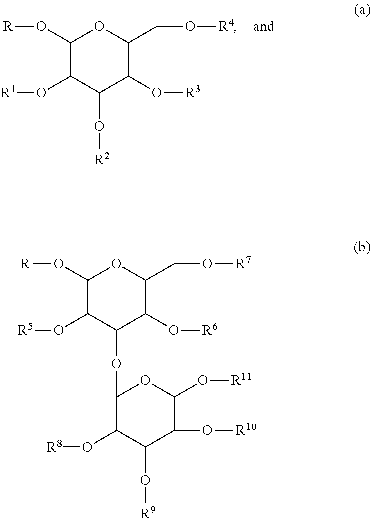
wherein:
R is an alkyl chain having 8 to 22 carbon atoms;
R¹, R², R³, R⁴ R⁵, R⁶, R⁷, R⁸, R⁹, R¹⁰, and R¹¹ are independently selected from the group consisting of: —CH₂—C(O)—O⁻M⁺, or —C(O)CH₂—C(O)—O⁻M⁺ 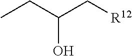
and H, with the proviso that R¹-R¹¹ are not all H;
R¹² is selected from the group consisting of:
—OH, —SO₃-M⁺, and —SO₄⁻²M⁺, —O—P(O)—(OM)₂,
—N(CH₃)₂—R^{1A}, —O—C(O)—CH₂—OH(SO₃⁻M⁺)—C(O)—O⁻-M⁺, 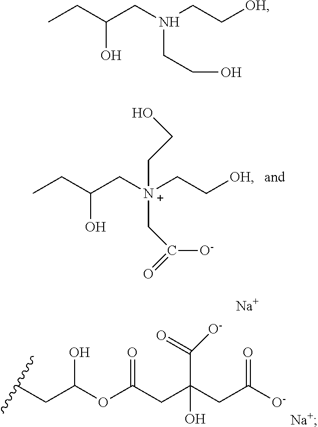
R^{1A} is CH₃—(CH₂)ₙ—;
M is a charge balancing group selected from H, Na, K, or NH₄⁺; and
n is an integer from 0-36;
and positional isomers thereof.

10. The composition of claim 1, wherein the derivatized alkyl polyglucoside surfactant is a composition that includes the following, as a mixture: 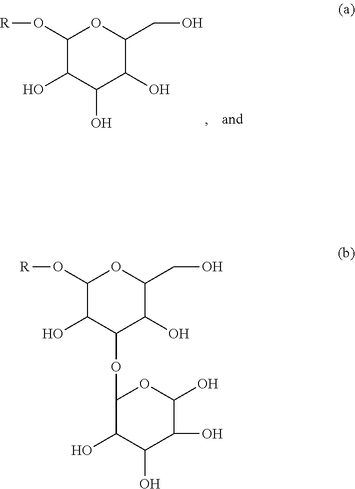
wherein:
R is an alkyl chain having 8 to 22 carbon atoms;
a crosslinking agent; and
a functionalizing agent selected from: 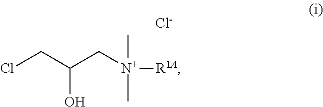
Cl—CH₂—CH(OH)—SO₃M, Cl—CH₂—CH(OH)—SO₄M, Cl—CH₂—CH(OH)—CH₂—OP(O)—(OM)₂, and combinations thereof, wherein
R^{1A} is CH₃(CH₂)ₙ—;
(ii) —Cl—CH₂—C(O)—O—⁻Na⁺, 2-halocarboxylic acid, α, β-unsaturated carboxylic acid, cyclic carboxylic acid anhydride, and combinations thereof, 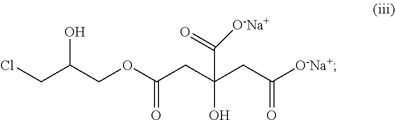
M is a charge balancing group selected from H, Na, K, or NH₄⁺; and
n is an integer from 0-36;
and positional isomers thereof.

11. The composition of claim 1, wherein the alkyl polyglucoside sorbitan ester crosspolymer surfactant is a composition that includes the following, as a mixture: 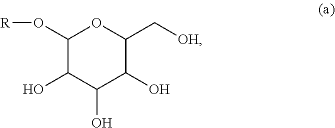
wherein;
R is alkyl having 8 to 22 carbon atoms; and 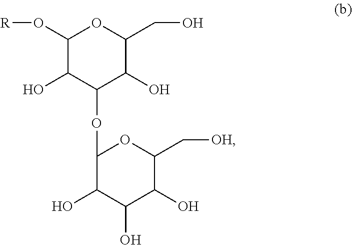
wherein:
R is alkyl having 8 to 22 carbon atoms; and
(c) a sorbitan ester of the following structure: 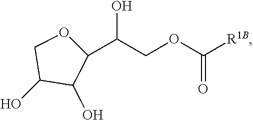
wherein:
R^{1B} is alkyl having 7 to 21 carbons;
a crosslinking agent of the following structure: 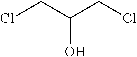
in water; and
optionally a functionalizing agent selected from the group of: 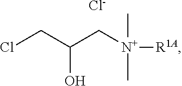
Cl—CH₂—CH(OH)—SO₃M, Cl—CH₂—CH(OH)—SO₄M,
Cl—CH₂—CH(OH)CH₂—OP(O)—(OM)₂, and mixtures thereof;
wherein R^{1A} is CH₃ (CH₂)ₙ—,
n is an integer from 0 to 36;
M is a charge balancing group selected from H, Na, K, or NH₄;
and positional isomers thereof.

12. The composition of claim 1, further comprising a co-surfactant.

13. The composition of claim 12, wherein the co-surfactant is a derivatized alkyl polyglucoside or alkyl polyglucoside sorbitan ester crosspolymer surfactant that is ethylene oxide and 1,4-dioxane free.

14. The composition of claim 12, wherein the co-surfactant is selected from alkyl polyglucosides, alkyl polyglucoside sorbitan ester crosspolymers, fatty alcohol ethoxylates, alkylphenol ethoxylates, phosphate esters of fatty alcohols, phosphate esters of fatty alcohol ethoxylates, phosphate esters of alkylphenol ethoxylates, sulfates of fatty alcohols, sulfates of fatty alcohol ethoxylates, sulfates of alkylphenol ethoxylates, sulfonates of fatty alcohols, sulfonates of fatty alcohol ethoxylates, sulfonates of alkylphenol ethoxylates, ethoxylated terpenes, phosphate esters of ethoxylated terpenes, sulfates of ethoxylated terpenes, sulfonates of ethoxylated terpenes, sulfosuccinates, quaternary amines, betaines, carboxymethylated fatty alcohols, carboxymethylated fatty alcohol ethoxylates, carboxymethylated alkylphenol ethoxylates, polyacrylic acid polymers, polymethacrylic acid polymers, gemini surfactants, polyols such as glycerol and glycerin, or tertiary amine surfactants.

15. The method for concentrating a desired mineral or metal:
combining a composition of claim 1 with an additional surfactant such as saponified fatty acid (i.e. oleic or tall oil fatty acid), DTO, CTO, petroleum sulfonate, xanthates, frothers, pH modifiers to form a beneficiation agent; and
apply the beneficiation agent to a mineral or metal ore body.

16. The method of claim 15 where the beneficiation agent is be applied neat at 100% or in combination with other components.

17. The method of claim 15 where the beneficiation agent is be further diluted in water.

18. The method of claim 15 where the beneficiation agent is sprayed onto the mineral surface and leach or extract the desired metal (in a heap leach, carbon in leach, or other leaching process) or added to a leaching solution like a pH modifier or cyanide solution.

19. The method of claim 15 where the beneficiation agent can be added to a mineral slurry, followed by application of aeration and turbulence.

20. The method of claim 15 where the beneficiation agent can be applied to a slurry and allowed to settle.

21. A method of extracting metal from a metal-bearing ore, the method comprising:
applying a surfactant composition of claim 1, and a leaching agent comprising an acid and/or a cyanide to the ore to form a treated ore;
subjecting the treated ore to a leaching process selected from dump leaching, heap leaching, vat leaching, or agitated leaching; and
recovering at least a portion of the metal, wherein the metal is at least one of gold, silver, and copper.

22. The method of claim 21, wherein the surfactant composition further comprises a high terpene-containing natural oil selected from, for example, orange peel oil, grapefruit peel oil, lemon peel oil, pine oil, and combinations thereof.

23. The method of claim 21, wherein the surfactant composition is applied in an amount of about 1 gram of surfactant composition to about 10,000 grams of surfactant composition per metric ton of metal-bearing ore.

24. The method of claim 21, wherein the surfactant composition is applied in an amount of about 10 grams of surfactant composition to about 100 grams of surfactant composition per metric ton of metal-bearing ore.

25. The method of claim 24, wherein the leaching process is heap leaching.

26. The method of claim 21, wherein the leaching agent comprises: nitric acid, hydrofluoric acid, hydrochloric acid, sulfuric acid, phosphoric acid, perchloric acid, a carbonate, a hydroxide base, gaseous ammonia, a cyanide salt, ferric sulfate, ferric chloride, cupric chloride, ferrous chloride, ozone, a thiosulfate salt, thiourea, thiosulfuric acid, dithiooxamide, a substituted dithiooxamide, a halogen-containing compound, or a combination thereof.

27. The method of claim 21, wherein the leaching agent is at least one of sodium cyanide, potassium cyanide, and calcium cyanide.

28. A method of improving leaching efficiency in a metal extraction process, the method comprising:
applying a surfactant composition of claim 1 to a metal-bearing ore; and
subjecting the metal-bearing ore to a leaching process selected from dump leaching, heap leaching, vat leaching, or agitated leaching, wherein the metal is at least one of gold, silver, and copper.

29. The method of claim 28, wherein the metal-bearing ore is comminuted before or during the applying.

30. A slurry, comprising:
water;
a metal-bearing ore comprising at least one of gold, silver, and copper;
a surfactant composition comprising one or more of the following:
a. at least one derivatized carbohydrate selected from an alkyl derivatized polyglycosides, glycolipid, glycerol glycolipid, sphingo glycolipid, sulfolipid, phospholipid, glucoside, rhamnolipid, sophrolipid;
b. at least one crosspolymer of an alkyl polyglucoside; and
a leaching agent comprising at least one of an acid and a cyanide wherein the slurry is disposed on a fixed bed.

31. The slurry of claim 30, further comprising a high terpene-containing natural oil selected from the group consisting of: orange peel oil, grapefruit peel oil, lemon peel oil, pine oil, and combinations thereof.

32. The slurry of claim 30, wherein the derivatized alkyl polyglucoside is chosen from a carboxymethyl derivatized alkyl polyglucoside, a quaternary derivatized alkyl polyglucoside, a sulfonate derivatized alkyl polyglucoside, a phosphate derivatized alkyl polyglucoside, a sulfosuccinate derivatized alkyl polyglucoside, a glycinate derivatized alkyl polyglucoside, and a citrate derivatized alkyl polyglucoside.

33. The slurry of claim 30, wherein the derivatized alkyl polyglucoside is chosen from a polysulfonate derivatized alkyl polyglucoside, polyphosphate derivatized alkyl polyglucoside, polyquaternary derivatized alkyl polyglucoside, polycarboxylated derivatized alkyl polyglucoside, and a polycitrate derivatized alkyl polyglucoside.

34. The slurry of claim 30, wherein the alkyl polyglucoside crosspolymer is a sorbitan ester alkylglucoside crosspolymer including sorbitan oleate decylglucoside crosspolymer.

35. The slurry of claim 30, wherein the derivatized polyglucoside surfactant of the present invention comprises a monosaccharide unit, a disaccharide unit, a linker, and a functionalizing agent.

36. The slurry of claim 30, wherein the derivatized polyglucoside surfactant of the present invention comprises a monosaccharide unit, a disaccharide unit, a crosslinking agent, and a functionalizing agent.

37. The slurry of claim 30, wherein the surfactant composition comprises an anionic surfactant selected from the group consisting of: an alkyl aryl sulfonate, an olefin sulfonate, a paraffin sulfonate, an alcohol sulfate, an alcohol ether sulfate, an alkyl carboxylate, an alkyl ether carboxylate, an ethoxylated alkyl phosphate ester, a monoalkyl sulfosuccinate, a dialkyl
